(19) United States
(12) Patent Application Publication
(10) Pub. No.: US 2020/0054425 A1
(43) Pub. Date: Feb. 20, 2020

(54) DENTAL SCALER DEPTH MEASUREMENT DEVICE FOR USE IN THE TREATMENT OF PERIODONTAL DISEASE

(71) Applicant: Erica Sliwa, Hoffman Estates, IL (US)

(72) Inventor: Erica Sliwa, Hoffman Estates, IL (US)

(21) Appl. No.: 16/105,854

(22) Filed: Aug. 20, 2018

(51) Int. Cl. A61C 17/20; A61C 19/04

(52) U.S. Cl. CPC A61C 17/20; A61C 19/043

(57) ABSTRACT

The present invention is directed to the treatment of periodontal disease. An ultrasonic scaler has a prong with measurement markings along tire prong. The dental instrument has an elongated body and a tip that is coupled to or formed contiguous with the elongated body. The scaler simultaneously cleans and provides a depth measurement by inserting the tip of the prong into the periodontal pocket depth of the space between the tooth and gum.

### CROSS-REFERENCES TO RELATED APPLICATIONS

(Not Applicable)

### STATEMENT REGARDING FEDERALLY-SPONSORED RESEARCH AND DEVELOPMENT

(Not Applicable)

### REFERENCE TO AN APPENDIX

(Not Applicable)

### BACKGROUND OF THE INVENTION

### 1. Field of the Invention

This invention relates generally to dental instruments and, specifically, to vibrating dental instruments and associated tips for performing dental procedures.

This invention relates generally to the treatment of periodontal disease and to the instruments employed for such treatment.

### 2. Description of the Related Art

Gum disease or Periodontal disease, including gingivitis, is an infection of the tissues that surround and support teeth feat can lead to destruction of the bone. Periodontal disease causes an inflammatory response to the surrounding bone and gum tissue. Periodontal disease is a leading cause of tooth loss; over three million people have the disease. Many patents are directed to the equipment for treating periodontal disease.

The progression of the stages of the disease are measured with a periodontal probe. The probe has markings for measuring the depth of the pocket between teeth and gum. A higher measurement indicates gingivitis or the start of periodontal disease. After The health of the gums is diagnoses by the dental professional, a patient typically needs a procedure called scaling and root planning, or deep-cleaning to remove the bacterial plaque, tartar, and toxins below the gum line, scaling the teeth and roots.

The procedure is done with tin ultrasonic scaler. An ultrasonic scaler is a instrument that works by having the tip resonate and vibrate to remove bacteria and plaque. The vibration causes sensitivity of the gums and roots, and blood, water, and saliva interferes and obstructs the vision of the dental professional.

There is a need in the industry for an ultrasonic sealer with measurement ability for the user to be able to know the depth of the pocket between gum and tooth. An ultrasonic sealer with inscribed or color coded measurement markings along the tip of the prong would facilitate exact reading of the depth of the pocket without guesswork as the tool is being used on a patient.

### BRIEF SUMMARY OF THE INVENTION

It is an object of the present invention to treat periodontal disease by providing a dental instrument device with depth control for a user to guide the instrument.

It is an object of the present invention to provide a means tor controlling working depth of an ultrasonic motor driven probe device.

It is an object of the present invention to provide a probe instrument that can be inserted into the gingival region between the tooth and gum to measure pocket depths around the tooth.

It is an object of the present invention to provide a means for assisting dental professionals in accurate diagnosis of the health of the tooth and gums.

### BRIEF DESCRIPTION OF THE SEVERAL VIEWS OF THE DRAWINGS

FIG. 1 is a view of the present ultrasonic scaler with measurement markings on the distal region of the prong.

FIG. 2 is a view of the prong of the invention being used to take a depth measurement between two teeth along a gumline.

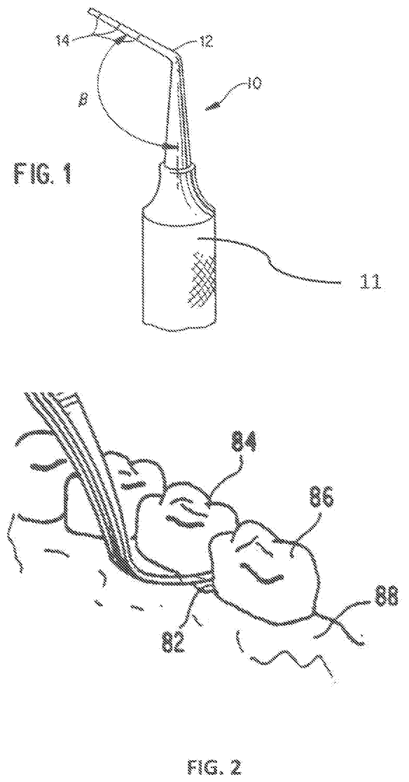

In describing the preferred embodiment of the invention which is illustrated in the drawings, specific terminology will be resorted to for the sake of clarity. However, it is not intended that the invention be limited to the specific term so selected and it is to be understood that each specific term includes all technical equivalents which operate in a similar manner to accomplish a similar purpose.

### DETAILED DESCRIPTION OF THE INVENTION

FIG.. 1 is a preferred embodiment of the invention depicting the ultrasonic scaler 10 with a handle 11 and an elongated prong 12. The prong 12 has a plurality of measurement markings 14 formed on the tip at a predetermined distance apart. The markings 14 serve as a means for depth measurement in the pocket between tooth and gum.

The prong 12 shown is the preferred embodiment, with etched measurement lines formed in the manufacturing of the prong 12. In an embodiment not shown, markings can in different color for measuring the pocket depth.

In FIG. 2. a gumline 88 with teeth 84 and 86 are depicted undergoing treatment. The scaler markings 14 are shown in use for a user to visually accurately measure the depth of the pocket area between the teeth 84 and 86. FIG. 2 show's the prong 12 in a pocket area between two teeth 84, 86.

In conclusion, the present invention in using the aforementioned structure has assuredly achieved anticipated effectiveness, moreover, contents of the present invention have not been publicly disclosed prior to this application and novelty, advancement and industrial practicability of the present invention clearly comply with essential elements as required for a new patent application. Accordingly, a new patent application is proposed herein.

It is of course to be understood that the embodiments described herein are merely illustrative of the principles of the invention and that a wide variety of modifications thereto may be effected by persons skilled in the art without departing from the spirit and scope of the invention as set forth in the following claims.

1. A hand-held ultrasonic dental apparatus for Inserting into an oral cavity to transmit ultrasonic energy from the radiating head to the teeth for cleaning, said apparatus comprising:
A. a vibrating member including:
1. a body member;
2. a prong coupled to said body member;
(a) said prong having defining a radiating surface disposed substantially parallel to the longitudinal axis of said vibrating member,
(b) a measurement means on said radiating surface for simultaneously measuring periodontal pocket depth and periodontal tooth attachment level.

2. The dental apparatus according to claim 1, where in said means for measurement is a series of etchings marks formed on the prong at a predetermined space apart from one another.
